(19) United States
(12) Patent Application Publication
(10) Pub. No.: US 2023/0088601 A1
(43) Pub. Date: Mar. 23, 2023

(54) METHOD FOR PROCESSING INCOMPLETE CONTINUOUS UTTERANCE AND SERVER AND ELECTRONIC DEVICE FOR PERFORMING THE METHOD

(71) Applicant: SAMSUNG ELECTRONICS CO., LTD., Suwon-si (KR)

(72) Inventors: Sangmin PARK, Suwon-si (KR); Gajin SONG, Suwon-si (KR)

(21) Appl. No.: 17/880,163

(22) Filed: Aug. 3, 2022

Related U.S. Application Data
(63) Continuation of application No. PCT/KR2022/010410, filed on Jul. 18, 2022.

(30) Foreign Application Priority Data
Sep. 15, 2021 (KR) 10-2021-0122838

(51) Int. Cl. G10L 15/22; G10L 15/30; G10L 15/16

(52) U.S. Cl. CPC G10L 15/22; G10L 15/30; G10L 15/16

(57) ABSTRACT

An intelligent server, to process incomplete continuous utterances, is configured to determine whether there is context information on a situation corresponding to a target utterance, when there is no context information on a situation corresponding to the target utterance, determine whether an intent of the target utterance is determinable without the context information on a situation corresponding to the target utterance, when the intent of the target utterance is not determinable without the context information on a situation corresponding to the target utterance, determine domain information and intent information, corresponding to the target utterance, with reference to learning data, and generate the processing result, based on the domain information and the intent information.

### CROSS-REFERENCE TO RELATED APPLICATIONS

This application is a continuation application of International Application No. PCT/KR2022/010410 designating the United States, filed on Jul. 18, 2022, in the Korean Intellectual Property Receiving Office and claiming priority to Korean Patent Application No. 10-2021-0122838, filed on Sep. 15, 2021, in the Korean Intellectual Property Office, the disclosures of which are incorporated by reference herein in their entireties.

### BACKGROUND

### 1. Field

The disclosure relates to an electronic device and intelligent server for processing a user utterance and an operating method thereof.

### 2. Description of Related Art

An electronic device including a voice assistant function for providing a service, based on a user utterance, has been widely distributed. The electronic device may recognize the user utterance through an artificial intelligence server and may figure out the meaning and intent of the user utterance. The artificial intelligence server may infer an intent of a user by interpreting an utterance of the user, perform tasks according to the inferred intent, and perform tasks according to the intent of the user expressed through interaction, in a natural language, between the user and the artificial intelligence server.

The artificial intelligence server may analyze various pieces of information on a situation at the moment of an utterance in connection with the utterance to figure out an intent of the utterance.

### SUMMARY

An intelligent server for processing a user utterance may classify an input utterance into a root utterance and a continuous utterance, based on continuity, and process the classified input utterance. The root utterance may be an independent complete sentence without context information on an utterance situation, such as a previous utterance or information on an application being executed. For example, utterances, such as “Show me today's weather” and “Call mom”, may be classified into the root utterance. The continuous utterance may be an utterance generated after a previous root utterance. For example, the utterance “How about yesterday?” generated after a root utterance “Show me today's weather” may be classified into a continuous utterance. An utterance, which reinforces an insufficient portion of a previous utterance using an incomplete utterance, may also be classified into a continuous utterance. For example, the utterance “to 10 minutes from now” generated after the utterance “Set the alarm” may be classified into a continuous utterance.

When receiving an incomplete continuous utterance without context information, such as a previous root utterance, the intelligent server may reject to process the received incomplete continuous utterance, which may otherwise be processible, or may match a service different from an utterance intent. For example, when the utterance “to 10 minutes from now” is input to the intelligent server after the previous utterance “Set the alarm”, the intelligent server may figure out a user's intent of “Set the alarm to 10 minutes from now” and may generate a suitable processing result. However, when receiving the utterance “to 10 minutes from now” without the previous utterance, the intelligent server may not process the utterance, corresponding to the user's intent.

According to an example embodiment, an intelligent server configured to process a user utterance includes a communication module (including, e.g., communication circuitry) configured to receive a target utterance from an electronic device and transmit a processing result of the target utterance to the electronic device; a memory configured to store utterance information, domain information for processing the utterance information, learning data including intent information determined based on the utterance information and the domain information, and computer-executable instructions; and a processor configured to execute the computer-executable instructions by accessing the memory, in which the computer-executable instructions configure the processor to determine whether there is context information on a situation corresponding to the target utterance; based on determining that there is no context information on a situation corresponding to the target utterance, determine whether an intent of the target utterance is determinable without the context information on a situation corresponding to the target utterance; based on the intent of the target utterance not being determinable without the context information on a situation corresponding to the target utterance, identify domain information and intent information, corresponding to the target utterance, with reference to the learning data; and generate the processing result, based on the domain information and the intent information, corresponding to the target utterance.

According to an example embodiment, a method of processing a user utterance in an intelligent server includes receiving a target utterance from an electronic device; determining whether there is context information on a situation corresponding to the target utterance; based on determining that there is no context information on a situation corresponding to the target utterance, determining whether an intent of the target utterance is determinable without the context information on a situation corresponding to the target utterance; based on the intent of the target utterance not being determinable without the context information on a situation corresponding to the target utterance, identifying domain information and intent information, corresponding to the target utterance, with reference to learning data; and generating a processing result of the target utterance, based on the domain information and the intent information, and transmitting the generated processing result to the electronic device, in which the learning data includes utterance information, domain information for processing the utterance information, and intent information determined based on the utterance information and the domain information.

According to an example embodiment, an electronic device configured to process a user utterance includes a memory configured to store utterance information, domain information for processing the utterance information, learning data including intent information determined based on the utterance information and the domain information, and computer-executable instructions; and a processor configured to execute the computer-executable instructions by accessing the memory, in which the computer-executable instructions configure the processor to determine whether there is context information on a situation corresponding to the target utterance received from a user; based on determining that there is no context information on a situation corresponding to the target utterance, determine whether an intent of the target utterance is determinable without the context information on a situation corresponding to the target utterance; based on the intent of the target utterance not being determinable without the context information on a situation corresponding to the target utterance, determine domain information and intent information, corresponding to the target utterance, with reference to the learning data; and generate the processing result, based on the domain information and the intent information, corresponding to the target utterance, and output the generated processing result to the user.

Various example embodiments of the disclosure may provide an intelligent server configured to determine a user's intent of an incomplete utterance without context information on an utterance situation, with reference to learning data, and generate a processing result corresponding to the user's intent.

Various example embodiments of the disclosure may provide an electronic device configured to determine a user's intent of an incomplete utterance without context information on an utterance situation, with reference to learning data, and generate a processing result corresponding to the user's intent.

In addition, various effects directly or indirectly ascertained through the present disclosure may be provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment, according to various example embodiments;

FIG. 2 is a block diagram illustrating an integrated intelligence system according to an example embodiment;

FIG. 3 is a diagram illustrating a screen of an electronic device processing a received voice input through an intelligent app, according to various example embodiments;

FIG. 4 is a diagram illustrating a form in which relationship information between concepts and actions is stored in a database, according to an example embodiment;

FIG. 5 is a block diagram illustrating an electronic device and an intelligent server, according to various example embodiments;

FIG. 6 is a diagram illustrating processing of an utterance, according to an example embodiment;

FIGS. 7, 8, 9A, and 9B are diagrams each illustrating an operation of processing an incomplete continuous utterance, according to various example embodiments;

FIG. 10 is a flowchart illustrating an operation of processing an incomplete continuous utterance by an intelligent server, according to various example embodiments; and

FIG. 11 is a flowchart illustrating an operation of an intelligent server when the number of domains corresponding to a target utterance is determined to be plural, according to various example embodiments.

### DETAILED DESCRIPTION

Hereinafter, various example embodiments will be described in greater detail with reference to the accompanying drawings. When describing the example embodiments with reference to the accompanying drawings, like reference numerals refer to like elements and a repeated description related thereto will be omitted.

<Electronic Device and Intelligent Server>

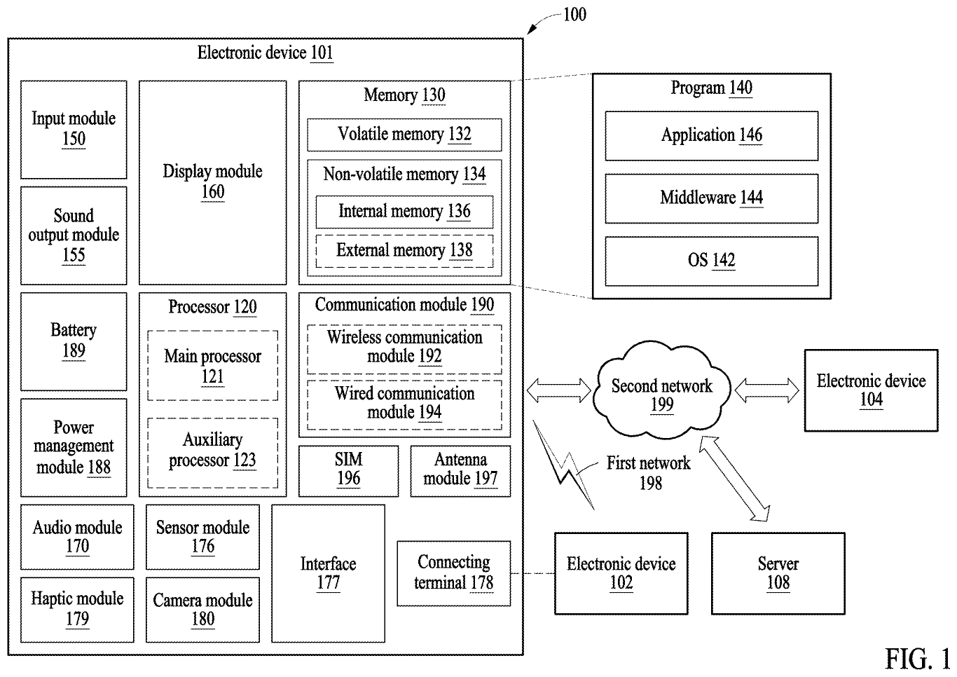

FIG. 1 is a block diagram illustrating an electronic device 101 in a network environment 100, according to various example embodiments.

Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various example embodiments, at least one of the components (e.g., the connecting terminal 178) may be omitted from the electronic device 101, or one or more other components may be added in the electronic device 101. In various example embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an example embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an example embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an example embodiment, the display module 160 may include a touch sensor adapted to sense a touch, or a pressure sensor adapted to measure an intensity of a force incurred by the touch.

The audio module 170 may convert a sound into an electric signal or vice versa. According to an example embodiment, the audio module 170 may obtain the sound via the input module 150 or output the sound via the sound output module 155 or an external electronic device (e.g., an electronic device 102 such as a speaker or a headphone) directly (e.g. wiredly) or wirelessly connected to the electronic device 101.

The sensor module 176 may detect an operational state (e.g., power or temperature) of the electronic device 101 or an environmental state (e.g., a state of a user) external to the electronic device 101 and generate an electrical signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, a Hall sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, ISPs, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196. The subscriber identification module 196 may include a plurality of subscriber identification modules. For example, the plurality of subscriber identification modules may store different subscriber information.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

According to various example embodiments, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an example embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

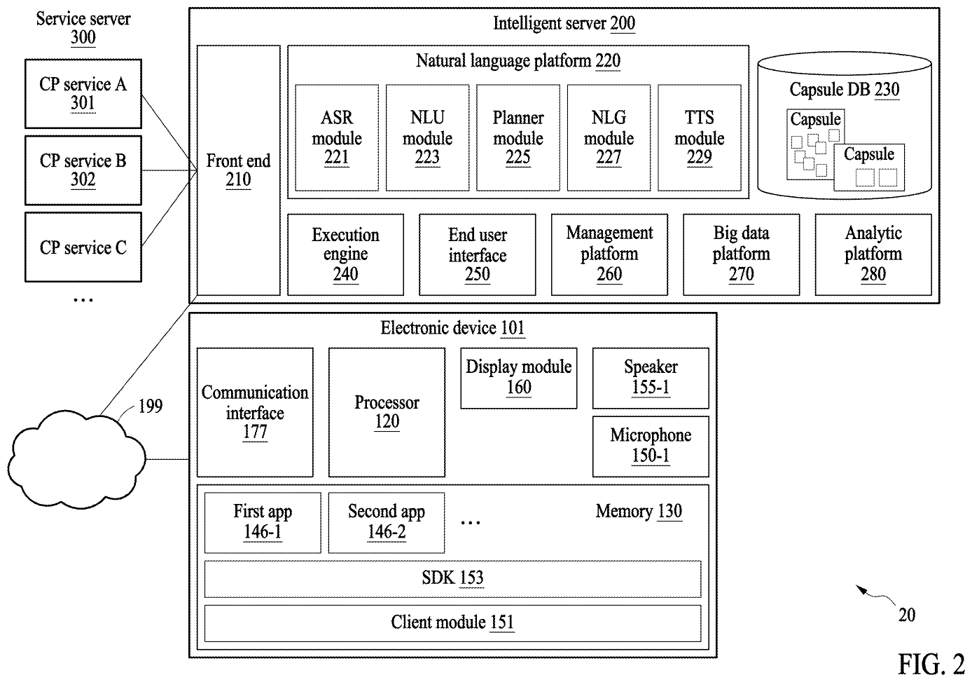

FIG. 2 is a block diagram illustrating an integrated intelligence system according to an example embodiment.

Referring to FIG. 2, an integrated intelligence system 20 may include an electronic device 101, an intelligent server 200, and a service server 300.

The electronic device 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the illustrated example embodiment, the electronic device 101 may include an interface 177, a microphone 150-1, a speaker 155-1, a display module 160, a memory 130, and a processor 120. The components listed above may be operationally or electrically connected to each other. The microphone 150-1 may be included in an input module (e.g., the input module 150 of FIG. 1). The speaker 155-1 may be included in a sound output module (e.g., the sound output module 155 of FIG. 1).

The interface 177 may be connected to an external device and configured to transmit and receive data to and from the external device. The microphone 150-1 may receive a sound (e.g., a user utterance) and convert the sound into an electrical signal. The speaker 155-1 may output the electrical signal as a sound (e.g., a speech). The display module 160 may be configured to display an image or video. The display module 160 may also display a graphical user interface (GUI) of an app (or an application program) being executed.

The memory 130 may store a client module 151, a software development kit (SDK) 153, and a plurality of apps 146. The client module 151 and the SDK 153 may configure a framework (or a solution program) for performing general-purpose functions. In addition, the client module 151 or the SDK 153 may configure a framework for processing a voice input. The plurality of apps 146 stored in the memory 130 may be programs for performing designated functions. The plurality of apps 146 may include a first app 146-1 and a second app 146-2. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected to the interface 177, the microphone 150-1, the speaker 155-1, and the display module 160 to perform a designated operation. The processor 120 may also perform the designated function by executing the program stored in the memory 130. For example, the processor 120 may execute at least one of the client module 151 or the SDK 153 to perform the following operation for processing a voice input. The processor 120 may control the operation of the plurality of apps 146 through, for example, the SDK 153. The following operation which is the operation of the client module 151 or the SDK 153 may be performed by the processor 120.

The client module 151 may receive a voice input. For example, the client module 151 may receive a voice signal corresponding to a user utterance sensed through the microphone 150-1. The client module 151 may transmit the received voice input to the intelligent server 200 over network 199. The client module 151 may transmit state information of the electronic device 101 together with the received voice input to the intelligent server 200. The state information may be, for example, execution state information of an app.

The client module 151 may receive a result corresponding to the received voice input. For example, when the intelligent server 200 calculates a result corresponding to the received voice input, the client module 151 may receive the result corresponding to the received voice input. The client module 151 may display the received result on the display module 160. Furthermore, the client module 151 may output the received result as audio through the speaker 155-1.

The client module 151 may receive a plan corresponding to the received voice input. The client module 151 may display results of executing a plurality of actions of an app according to the plan on the display module 160. The client module 151 may, for example, sequentially display the results of executing the plurality of actions on the display module 160 and/or output the results as audio through the speaker 155-1. As another example, the electronic device 101 may display only a partial result of executing the plurality of actions (e.g., a result of the last action) on the display module 160 and/or output the portion of the results as audio through the speaker 155-1.

According to an example embodiment, the client module 151 may receive a request for obtaining information necessary for calculating a result corresponding to the voice input from the intelligent server 200. According to an example embodiment, the client module 151 may transmit the necessary information to the intelligent server 200 in response to the request.

The client module 151 may transmit information on the results of executing the plurality of actions according to the plan to the intelligent server 200. The intelligent server 200 may confirm that the received voice input has been correctly processed using the information on the results.

The client module 151 may include a speech recognition module. According to an example embodiment, the client module 151 may recognize a voice input for performing a limited function through the speech recognition module. For example, the client module 151 may execute an intelligent app for processing a voice input to perform an organic operation through a designated input (e.g., Wake up!).

The intelligent server 200 may receive information related to a user voice input from the electronic device 101 through a communication network. According to an example embodiment, the intelligent server 200 may change data related to the received voice input into text data. According to an example embodiment, the intelligent server 200 may generate a plan for performing a task corresponding to the user voice input based on the text data.

According to an example embodiment, the plan may be generated by an artificial intelligence (AI) system. The artificial intelligence system may be a rule-based system or a neural network-based system (e.g., a feedforward neural network (FNN) or a recurrent neural network (RNN)). Alternatively, the artificial intelligence system may be a combination thereof or other artificial intelligence systems. According to an example embodiment, the plan may be selected from a set of predefined plans or may be generated in real time in response to a user request. For example, the artificial intelligence system may select at least one plan from among the predefined plans.

The intelligent server 200 may transmit a result according to the generated plan to the electronic device 101 or transmit the generated plan to the electronic device 101. According to an example embodiment, the electronic device 101 may display the result according to the plan on the display module 160. According to an example embodiment, the electronic device 101 may display a result of executing an action according to the plan on the display module 160.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received voice input from the electronic device 101. The front end 210 may transmit a response corresponding to the voice input.

According to an example embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 101 into text data. The NLU module 223 may discern an intent of a user using the text data of the voice input. For example, the NLU module 223 may discern the intent of the user by performing syntactic analysis or semantic analysis. The NLU module 223 may discern the meaning of a word extracted from the voice input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. According to an example embodiment, the planner module 225 may determine a plurality of domains required to perform a task based on the determined intent. The planner module 225 may determine a plurality of actions included in each of the plurality of domains determined based on the intent. According to an example embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine a relationship between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an example embodiment, some or all of the functions of the natural language platform 220 may be implemented in the electronic device 101 as well.

The capsule DB 230 may store information on the relationship between the plurality of concepts and actions corresponding to the plurality of domains. A capsule according to an example embodiment may include a plurality of action objects (or action information) and concept objects (or concept information) included in the plan. According to an example embodiment, the capsule DB 230 may store a plurality of capsules in the form of a concept action network (CAN). According to an example embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the voice input. According to an example embodiment, the capsule DB 230 may include a follow-up registry that stores information on follow-up actions for suggesting a follow-up action to the user in a designated situation. The follow-up action may include, for example, a follow-up utterance. According to an example embodiment, the capsule DB 230 may include a layout registry that stores layout information that is information output through the electronic device 101. According to an example embodiment, the capsule DB 230 may include a vocabulary registry that stores vocabulary information included in capsule information. According to an example embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an example embodiment, the capsule DB 230 may be implemented in the electronic device 101 as well.

The execution engine 240 may calculate or obtain a result using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., food order or hotel reservation) to the electronic device 101. In FIG. 2, service server provides CP service A 301, CP service B 302, CP service C 303, etc. According to an example embodiment, the service server 300 may be a server operated by a third party. The service server 300 may provide information to be used for generating a plan corresponding to the received voice input to the intelligent server 200. The provided information may be stored in the capsule DB 230. In addition, the service server 300 may provide result information according to the plan to the intelligent server 200.

In the integrated intelligence system 20 described above, the electronic device 101 may provide various intelligent services to the user in response to a user input. The user input may include, for example, an input through a physical button, a touch input, or a voice input.

In an example embodiment, the electronic device 101 may provide a speech recognition service through an intelligent app (or a speech recognition app) stored therein. In this case, for example, the electronic device 101 may recognize a user utterance or a voice input received through the microphone and provide a service corresponding to the recognized voice input to the user.

In an example embodiment, the electronic device 101 may perform a designated action alone or together with the intelligent server and/or a service server, based on the received voice input. For example, the electronic device 101 may execute an app corresponding to the received voice input and perform a designated action through the executed app.

In an example embodiment, when the electronic device 101 provides a service together with the intelligent server 200 and/or the service server, the electronic device 101 may detect a user utterance using the microphone 150-1 and generate a signal (or voice data) corresponding to the detected user utterance. The electronic device 101 may transmit the speech data to the intelligent server 200 using the interface 177.

The intelligent server 200 may generate, as a response to the voice input received from the electronic device 101, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 101 may receive the response using the interface 177. The electronic device 101 may output a voice signal internally generated by the electronic device 101 to the outside using the speaker 155-1, or output an image internally generated by the electronic device 101 to the outside using the display module 160.

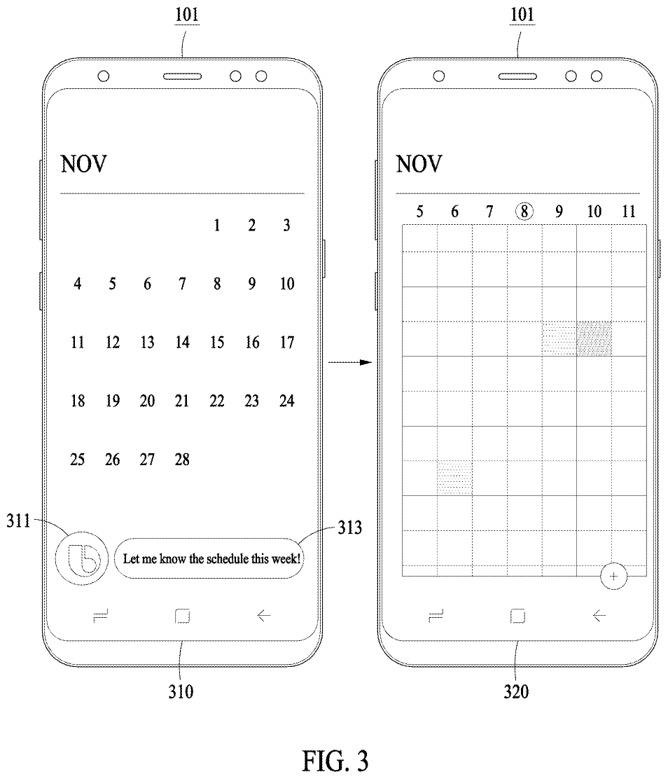

FIG. 3 is a diagram illustrating a screen of an electronic device processing a received voice input through an intelligent app, according to various example embodiments.

An electronic device 101 may execute an intelligent app to process a user input through an intelligent server (e.g., the intelligent server 200 of FIG. 2).

According to an example embodiment, on a screen 310, when a designated voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, in a state in which a scheduling app is executed. According to an example embodiment, the electronic device 101 may display an object (e.g., an icon) 311 corresponding to the intelligent app on a display (e.g., the display module 160 of FIG. 1). According to an example embodiment, the electronic device 101 may receive a voice input by a user utterance. For example, the electronic device 101 may receive a voice input of “Let me know the schedule this week!”. According to an example embodiment, the electronic device 101 may display a user interface (UI) 313 (e.g., an input window) of the intelligent app in which text data of the received voice input is displayed on the display.

According to an example embodiment, on a screen 320, the electronic device 101 may display a result corresponding to the received voice input on the display. For example, the electronic device 101 may receive a plan corresponding to the received user input, and display “the schedules this week” on the display according to the plan.

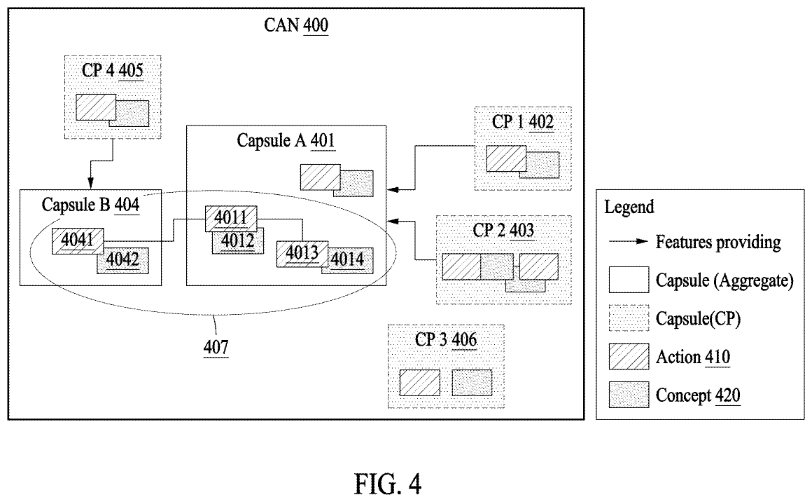

FIG. 4 is a diagram illustrating a form in which relationship information between concepts and actions is stored in a database, according to an example embodiment.

A capsule DB (e.g., the capsule DB 230 of FIG. 2) of an intelligent server (e.g., the intelligent server 200 of FIG. 2) may store capsules in the form of a concept action network (CAN) 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains (e.g., applications). According to an example embodiment, one capsule (e.g., the capsule A 401) may correspond to one domain (e.g., a location (geo) or an application). Further, the one capsule may correspond to at least one service provider (e.g., CP 1 402 or CP 2 403) for performing a function for a domain related to the capsule. According to an example embodiment, one capsule may include at least one action 410 for performing a designated function and at least one concept 420.

A natural language platform (e.g., the natural language platform 220 of FIG. 2) may generate a plan for performing a task corresponding to a received voice input using the capsules stored in the capsule DB. For example, a planner module (e.g., the planner module 225 of FIG. 2) of the natural language platform may generate the plan using the capsules stored in the capsule DB. For example, a plan 407 may be generated using actions 4011 and 4013 and concepts 4012 and 4014 of the capsule A 401 and an action 4041 and a concept 4042 of the capsule B 404.

The electronic device according to various example embodiments may be one of various types of electronic devices. The electronic device may include, for example, a portable communication device (e.g., a smartphone), a computer device, a portable multimedia device, a portable medical device, a camera, a wearable device, or a home appliance device. According to an example embodiment of the disclosure, the electronic device is not limited to those described above.

It should be understood that various example embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “1st”, “2nd”, or “first” or “second” may simply be used to distinguish the component from other components in question, and may refer to components in other aspects (e.g., importance or order) is not limited. It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various example embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an example embodiment, the module may be implemented in the form of an application-specific integrated circuit (ASIC).

Various example embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Here, the “non-transitory” storage medium may refer, for example, to a tangible device, and does not include a signal (e.g., an electromagnetic wave), but this term does not differentiate between where data is semi-permanently stored in the storage medium and where the data is temporarily stored in the storage medium.

According to an example embodiment, a method according to various example embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various example embodiments, each component (e.g., a module or a program) of the above-described components may include a single entity or multiple entities, and some of the multiple entities may be separately disposed in different components. According to various example embodiments, one or more of the above-described components may be omitted, or one or more other components may be added. Alternatively or additionally, a plurality of components (e.g., modules or programs) may be integrated into a single component. In such a case, according to various example embodiments, the integrated component may still perform one or more functions of each of the plurality of components in the same or similar manner as they are performed by a corresponding one of the plurality of components before the integration. According to various example embodiments, operations performed by the module, the program, or another component may be carried out sequentially, in parallel, repeatedly, or heuristically, or one or more of the operations may be executed in a different order or omitted, or one or more other operations may be added.

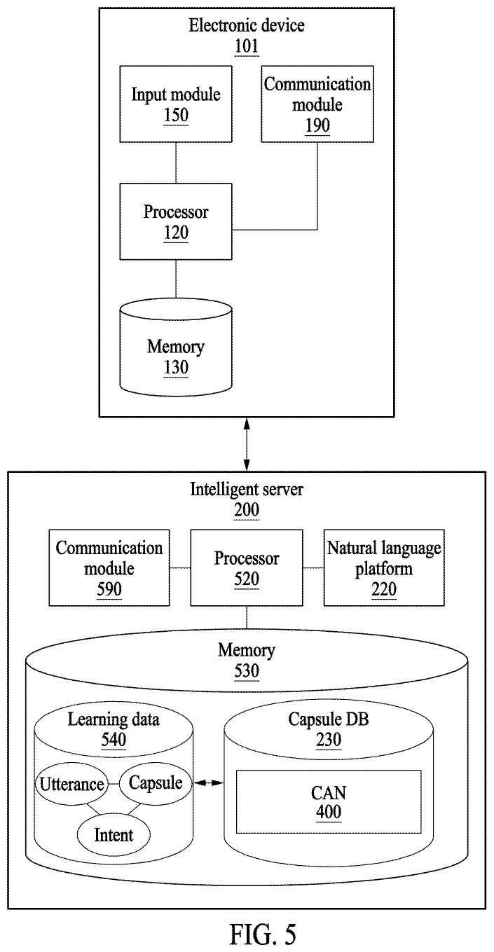

FIG. 5 is a block diagram illustrating an electronic device 101 and an intelligent server 200, according to various example embodiments.

The electronic device 101 of FIG. 5 may include at least some of the components of the electronic device 101 described with reference to FIG. 1 and the electronic device 101 described with reference to FIG. 2. The intelligent server 200 of FIG. 5 may include at least some of the components of the intelligent server 200 described with reference to FIG. 2. With respect to the electronic device 101 and the intelligent server 200 of FIG. 5, the descriptions provided with reference to FIGS. 1 through 4 are not repeated.

Referring to FIG. 5, the electronic device 101 may include an input module 150 for inputting a user utterance to the electronic device 101, a communication module 190 for communicating with the intelligent server 200 configured to process the user utterance, a memory 130 for storing computer-executable instructions, and/or a processor 120 for executing the computer-executable instructions by accessing the memory 130. The electronic device 101, the input module 150, the communication module 190, the memory 130, and/or the processor 120 may respectively correspond to the electronic device 101, the input module 150, the communication module 190, the memory 130, and/or the processor 120 described with reference to FIG. 1. The electronic device 101 may be the electronic device 101 for performing communication with the intelligent server 200 described with reference to FIG. 2, or the client module 151 described with reference to FIG. 2 may be included in the memory 130.

The processor 120 may receive a user utterance through the input module 150 and transmit, to the intelligent server 200, the user utterance and context information on the electronic device 101, which is obtained in response to the user utterance. The context information on the electronic device 101 may include at least one of information on the specifications of the electronic device 101, such as account information of the electronic device 101, information on a maximum supported volume, and/or information on whether the electronic device 101 is a specialized device, information on whether the electronic device 101 is locked, information on a current position of the electronic device 101, information on a value set for a ringtone, information on an application currently being executed on the electronic device 101, information on a folding state of the electronic device 101, and information on whether the position information is used. For example, the context information on the electronic device 101 may be represented in Table 1. However, the context information is not limited to the Table 1 examples, and the processor 120 may transmit various pieces of context information to the intelligent server 200.

TABLE 1

| Context | Description | Value |
|---|---|---|
| device locked | whether a device is locked | true/false |
| latitude, longitude | current position | double |
| location disabled | whether position information is used | true/false |
| ringer state | a current value set for a ringtone | alarm/phone/ |
| | | timer/other |
| driving mode | whether a user is driving | true/false |
| | (whether a navigation app is used) | |
| fold state | a current state of a foldable terminal | true/false |
| focused app | information on a currently executed | |
| | application package | |

The processor 120, may transmit, to the intelligent server 200 through the communication module 190, a user utterance and context information on the electronic device 101, which is obtained in response to the user utterance, and output, to a user, a processing result received from the intelligent server 200.

The intelligent server 200 may include a natural language platform 220, a capsule DB 230, a communication module 590, a processor 520, and/or a memory 530. The intelligent server 200 may be the intelligent server 200 described with reference to FIG. 2, and the communication module 590, the processor 520, the memory 530, the natural language platform 220, and/or the capsule DB 230 may correspond to the elements of the intelligent server 200 of FIG. 2.

The communication module 590 may correspond to the front end 210 of FIG. 2. The processor 520 may receive, from the electronic device 101 through the communication module 590, a user utterance and context information on the electronic device 101, which is obtained in response to an utterance situation. The intelligent server 200, through the communication module 590, may receive, from the electronic device 101 and another electronic device (not shown) connected to the electronic device 101, an utterance and context information (e.g., specification information of an electronic device, a history of apps used by an electronic device, an utterance history, etc.), in response to an utterance situation. For example, at home, a user may use various electronic devices, such as an intelligent speaker, a smart TV, and/or smart appliances, corresponding to a user's account of the electronic device 101 (e.g., a smartphone). The intelligent server 200 may receive, from the intelligent speaker and/or the smart appliances, in addition to the smartphone, device specification information, utterance history information, and/or executed application history information and may store data.

The processor 520 may generate a processing result of an utterance received from the electronic device 101 and transmit the processing result to the electronic device 101 through the communication module 590.

The natural language platform 220, as described with reference to FIG. 2, may include an ASR module 221, an NLU module 223, a planner module 225, an NLG module 227, and a TTS module 229. The memory 530 may include the capsule DB 230. As described with reference to FIG. 2, the capsule DB 230 may store an action for processing a task corresponding to a voice input of a user and a parameter necessary for the action in the form of a CAN 400. The CAN 400 may be configured as described with reference to FIG. 4.

The memory 530 of the intelligent server 200 may store learning data 540. The learning data 540 may include utterance information, capsule information for processing the utterance information, and intent information determined based on the utterance information and the capsule information. As described with reference to FIGS. 2 through 4, the capsule information may correspond to domain information (e.g., a position, an application, etc.). The domain information may be software for processing a target utterance through the electronic device 101 and may include at least one of an application downloadable to the electronic device 101, a program for providing a service in the form of a widget, or a web app.

The learning data 540 and the capsule DB 230 are separately illustrated in FIG. 5, but the disclosure is not limited in this respect, and the learning data 540 may be included in the capsule DB 230.

The memory 530 for storing computer-executable instructions and the processor 520 for executing the computer-executable instructions by accessing the memory 530 may correspond to the natural language platform 220 or the execution engine 240 of the intelligent server 200. For example, the processor 520 may generate a plan with reference to the learning data 540 or the capsule DB 230, as described on the natural language platform 220 in FIG. 2, and may generate a processing result according to the plan, as described on the execution engine 240 in FIG. 2.

The processor 520, through the communication module 590, may receive a target utterance from the electronic device 101, generate a processing result of the target utterance with reference to the natural language platform 220, the capsule DB 230, and the learning data 540, and transmit the generated processing result to the electronic device 101.

When there is no context information on a situation corresponding to the target utterance received from the electronic device 101 and an intent of the target utterance is not determinable without the context information, a program (e.g., the program 140 of FIG. 1) for determining domain information and intent information, corresponding to the target utterance, with reference to the learning data 540, and for generating a processing result, based on the domain information and the intent information, may be stored in the memory 530 as software.

On-device AI for processing an utterance without communication with the intelligent server 200 may be included in the electronic device 101. As described with reference to FIGS. 2 through 4, the natural language platform 220 and/or the capsule DB 230 may be implemented in the electronic device 101, and the learning data 540 may also be included in the memory 130 of the electronic device 101. When there is no context information on a situation corresponding to the target utterance received from a user in the memory 130 of the electronic device 101 and an intent of the target utterance is not determinable without the context information, a program (e.g., the program 140 of FIG. 1) for determining domain information and intent information, corresponding to the target utterance, with reference to the learning data 540, and for generating a processing result, based on the domain information and the intent information, may be stored as software.

When the electronic device 101 includes on-device AI and a function of an intelligent server is implemented in the electronic device 101, only some of the function of the intelligent server may be implemented in the electronic device 101. For example, only some of the components (e.g., the ASR module 221) of the natural language platform 220 of the intelligent server 200 described with reference to FIG. 2 may be implemented in the electronic device 101. As another example, only the natural language platform 220 of the intelligent server 200 may be implemented in the electronic device 101, and the capsule DB 230 or the learning data 540 may be maintained in the intelligent server 200.

The computer-executable instructions stored in the memory 530 or the memory 130 may be implemented as one function module in the OS 142, implemented in the form of the middleware 144, or implemented by a separate application (e.g., the application 146).

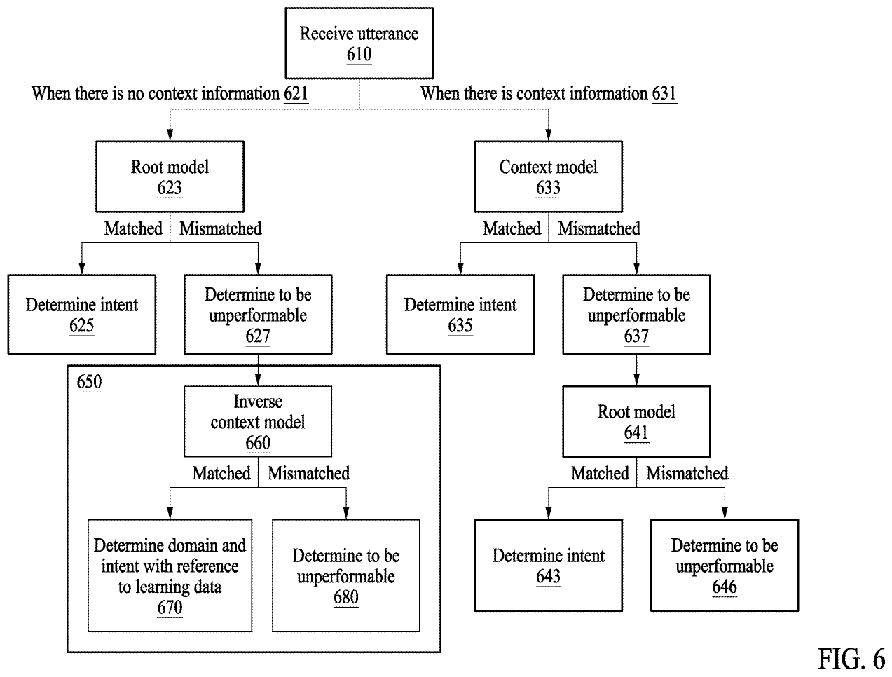

An operation of generating a processing result with reference to the learning data 540, when the processor 120 of the electronic device 101 or the processor 520 of the intelligent server 200 is not able to determine an intent of a target utterance without context information on a situation corresponding to the target utterance, will be described in detail with reference to FIGS. 6, 7, 8, 9A, and 9B.

FIG. 6 is a diagram illustrating processing of an utterance, according to an example embodiment.

An operation of processing an utterance illustrated in FIG. 6 may be performed by the processor 520 of the intelligent server 200 described with reference to FIG. 5, and as described with reference to FIG. 5, may be performed by the processor 120 of the electronic device 101 when the electronic device 101 includes on-device AI. Hereinafter, a flow of processing an utterance is described based on the processor 520 of the intelligent server 200.

The processor 520, after receiving an utterance in operation 610, may process the utterance using different models according to whether there is context information on a situation of the utterance.

When there is no context information as determined in operation 621, the processor 520 may process the utterance using a root model 623 with reference to the natural language platform 220 and the capsule DB 230. For example, when receiving an utterance, such as “Show me today's weather” or “Call mom”, the processor 520 may determine, in operation 625, a matched intent with the utterance with reference to the natural language platform 220 and the capsule DB 230, without the context information, such as a previous utterance and/or information on an application currently being executed by the electronic device 101. For example, the processor 520 may provide today's weather to a user through a weather application or may generate a processing result of calling the user's mom through a call application.

When there is context information as determined in operation 631, the processor 520 may process the utterance using a context model 633 with reference to the natural language platform 220 and the capsule DB 230. For example, in operation 610, the target utterance “to 10 minutes from now” may be received from the electronic device 101, in response to a processing result of “To what time do you want to set the alarm?” generated by the intelligent server 200 in response to the utterance “Set the alarm”. Since there is context information, which is the utterance “Set the alarm” prior to the target utterance, in operation 635, the processor 520 may determine a matched intent with the target utterance using the context model 633. Specifically, the processor 520 may determine a capsule (or domain information), based on the target utterance “to 10 minutes from now” and the context information, which is the utterance “Set the alarm”, using the context model 633, and in operation 635, the processor 520 may determine a matched intent with the target utterance in the capsule. For example, the processor 520 may generate a processing result of setting the alarm to 10 minutes from now through an alarm application.

When the processor 520 processes an utterance using the context model 633 because there is context information as determined in operation 631, but the utterance is not processible because there is no matched intent with the utterance, the processor 520 may reprocess the utterance using the root model 641. For example, when receiving the utterance “Call mom” within a certain time after the utterance “Show me today's weather”, there may be context information, which is a previous utterance, the utterance “Show me today's weather”, as determined in operation 631, but the utterance is irrelevant to the target utterance, which is the utterance “Call mom”. Therefore, in operation 637, the utterance “Call mom” may be determined to be not processible (unperformable) by the context model 633. In this case, the processor 520 may determine whether the utterance “Call mom” is processible by the root model 641, and in operation 643, may determine a matched intent with the utterance. For example, the processor 520 may generate a processing result of calling a user's mom through a call application.

The processor 520, while processing an utterance using the root model 623 or the context model 633, may use an encoder based on Bidirectional Encoder Representations from Transformers (BERT) and a gazetteer encoder.

The processor 520 may generate a processing result using an inverse context model 660 when receiving an incomplete continuous utterance, which is a continuous utterance without context information. Hereinafter, described are examples to which operation 650 of processing an utterance using the inverse context model 660 is applicable.

When receiving a continuous utterance, such as the utterance “to 10 minutes from now”, without a previous utterance, such as “Set the alarm”, the processor 520, since there is no context information as determined in operation 621, may determine that an utterance intent is not determinable only with the utterance “to 10 minutes from now” and may determine the utterance “to 10 minutes from now” to be not processible (unperformable) in operation 627. The inverse context model 660 may be used when there is no context information, and an utterance is not processible by the root model 623 without the context information.

When receiving the utterance “to 10 minutes from now” after the utterance “Show me today's weather”, the processor 520 may process the utterance “to 10 minutes from now” using the context model 633 since there is context information, which is the utterance “Show me today's weather”. However, in operation 637, the utterance “to 10 minutes from now” may not be processible using the context model 633. Accordingly, the utterance may be reprocessed by the root model 641, but with the utterance “to 10 minutes from now” only, an utterance intent may not be determinable and the utterance may be determined to be not processible (unperformable) in operation 646. As such, when there is context information, which is the utterance “Show me today's weather”, not corresponding to a target utterance, which is the utterance “to 10 minutes from now”, and the target utterance is not processible by the root model 641, the inverse context model 660 may be used. In an embodiment with reference to FIG. 6, for brevity, it has been described that the inverse context model 660 is applied for processing of an utterance in operation 650 when the utterance is determined to be unperformable in operation 627 by the root model 623. However, even when the utterance is processed to be unperformable in operation 646, the inverse context model 660 may be applied to process the utterance. Hereinafter, a processing operation of the inverse context model 660 is described.

In an utterance processing operation of the context model 633, the processor 520 may determine a capsule (or domain information) using context information corresponding to a received target utterance and may determine an intent of the received target utterance by determining whether to process the received target utterance in the determined capsule (or domain). The inverse context model 660, with reference to the learning data 540 including utterance information, capsule information (or domain information), and intent information, may inversely search for and classify a capsule having a similar utterance to a target utterance and determine the domain information and the intent information. The learning data 540 may include pieces of continuous utterance information and capsules (or pieces of domain information) respectively corresponding to the pieces of continuous utterance information. For example, the learning data 540 may include a reminder and a calendar as a domain corresponding to the continuous utterance, “to 10 minutes from now”. As another example, the learning data 540 may include a text message and an email as a domain corresponding to the continuous utterance, “Mark as all read”.

As described with reference to FIG. 5, the learning data 540 may include utterance information, for example, “to 10 minutes from now”, domain information, which is an “alarm application”, corresponding to the utterance information, and an utterance intent, which is “Set the alarm to 10 minutes from now with the alarm application”. In operation 670, the processor 520, with reference to the learning data 540, without a previous utterance, “Set the alarm”, or context information that the alarm application is currently being executed, may determine the domain information, which is the “alarm application”, corresponding to the utterance, “to 10 minutes from now”, and the intent information, which is “Set the alarm to 10 minutes from now with the alarm application”.

When there is no intent information even with reference to the learning data 540, the processor 520 may determine that an utterance is not processible (unperformable) in operation 680. For example, when receiving the utterance, “Jiwoo is three years old” without context information corresponding to the utterance, the processor 520 may determine that the utterance is not processible (unperformable) both by the root model 623 and the inverse context model 660. The processor 520 may generate a processing result, for example, “I don't understand what you mean”.

The inverse context model 660 may have excellent scalability because the inverse context model 660 uses the learning data 540 using existing data (e.g., the capsule DB 230), in which a separate predefinition is not needed, and when adding a new capsule, a separate operation is not needed.

The utterance processing operation of the processor 520 illustrated in FIG. 6 may be represented as computer-readable instructions below.

```
if(context == null && utterance == partial)
  capsule_list[ ] = inverseContextModel(utterance)
    if (capsule_list[0] > threshold)
      return “run” + capsule_list[0]
    else
      return “please select among” + capsule_list[ ]
else if(context != null)
  capsule_list[ ] = contextModel(utterance)
else
  capsule_list[ ] = rootModel(utterance)
```

According to an example embodiment, the learning data 540 may be used in a learning engine that is implemented in the form of a rule engine, and based on the rule engine, the processor 520 may determine domain information and intent information corresponding to a target utterance. According to another example embodiment, the learning data 540 may be used in a learning engine that is implemented in the form of a neural network engine, and based on a result derived by inputting a target utterance to the neural network engine, the processor 520 may determine domain information and intent information.

The number of domains determined with reference to the learning data 540 may be plural, and the processor 520 may calculate correspondences of the domains to a target utterance as scores. For example, when the number of domains determined with reference to the learning data 540 through the inverse context model 660 by the processor 520 is plural, the processor 520 may determine, as a correspondence, a probability of each of the domains to correspond to a target utterance.

When a correspondence of a domain having the highest correspondence is greater than or equal to a threshold, the processor 520 may generate a processing result of a target utterance, based on information on the domain having the highest correspondence and intent information. When the correspondence of the domain having the highest correspondence is less than the threshold, the processor 520 may generate a processing result requesting a user's confirmation (hereinafter, referred to as a user confirmation) on a domain for processing the target utterance among the domains.

The threshold for determining the domain for processing the target utterance may be determined in various methods. According to an example embodiment, the threshold may be determined based on the probability of a domain and the target utterance to correspond to each other, uncertainty between the domain and the target utterance, and/or perplexity, which is an indicator of a difference between the domain and the target utterance. According to another example embodiment, the threshold may be determined based on a predefined test.

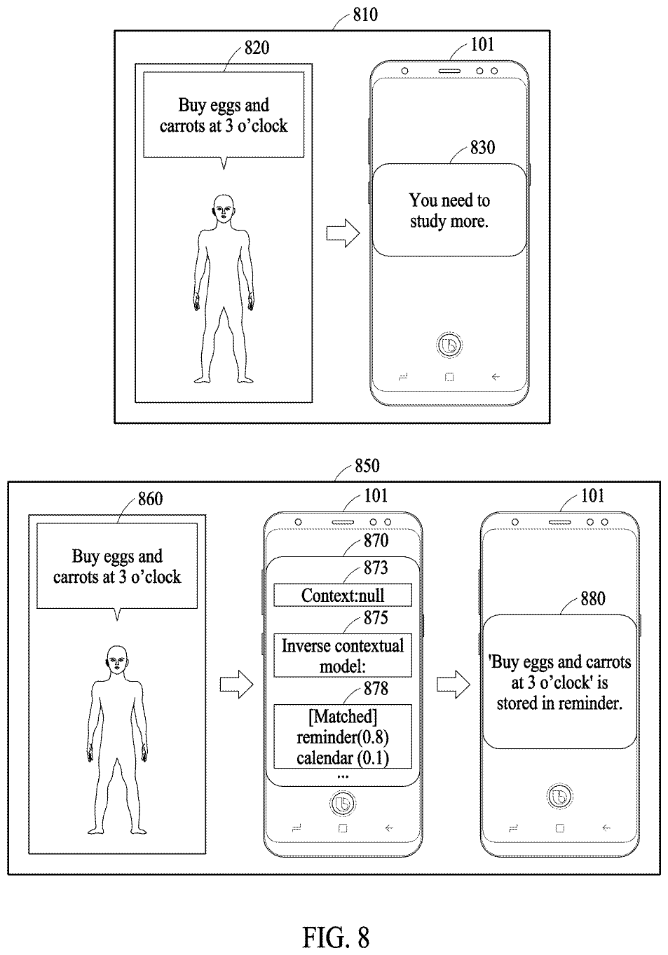

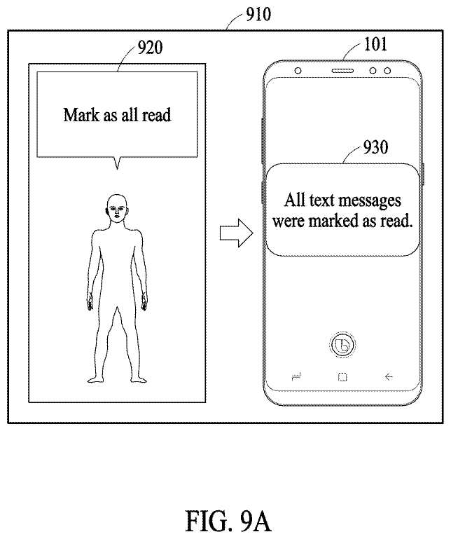

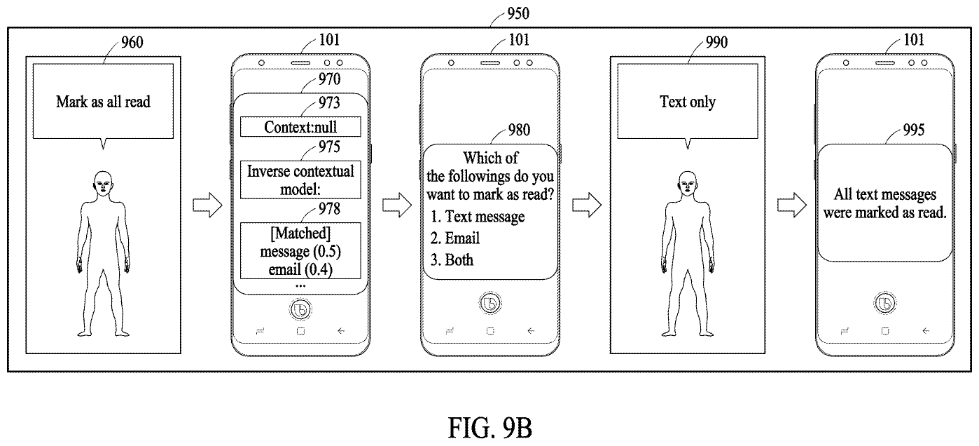

Examples in which the number of domains determined with reference to the learning data 540 is plural will be described in detail with reference to FIGS. 8, 9A, and 9B.

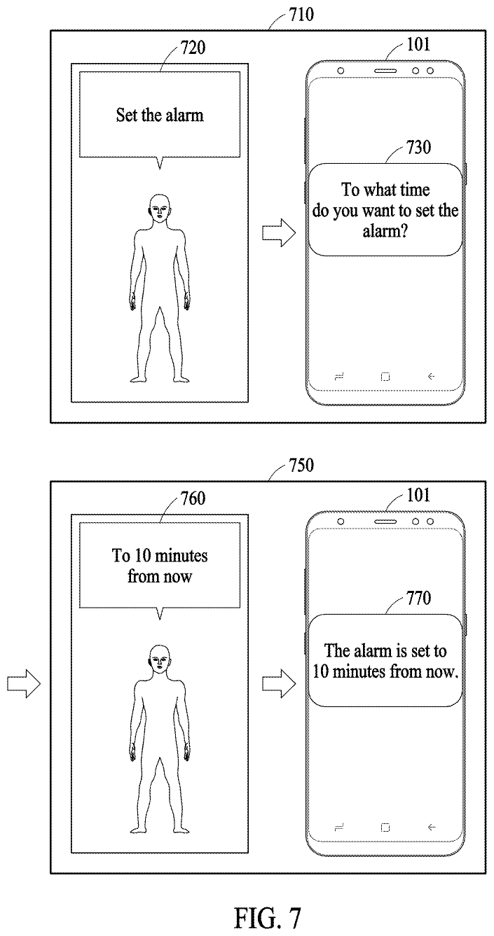

Various example embodiments in which the processor 520, with reference to the learning data 540, processes an incomplete continuous utterance, which is a continuous utterance without context information, will be provided with reference to FIGS. 7, 8, 9A, and 9B.

FIGS. 7, 8, 9A, and 9B are diagrams each illustrating an operation of processing an incomplete continuous utterance, according to various example embodiments.

Referring to FIG. 7, an example embodiment is illustrated in which an utterance situation 750, “to 10 minutes from now”, follows an utterance situation 710, “Set the alarm”.

In the utterance situation 710, the processor 520 may generate a processing result 730 of “To what time do you want to set the alarm?” in response to an utterance 720 of “Set the alarm” and may output the processing result 730 to a user through the electronic device 101.

In the utterance situation 750 after the utterance situation 710, a target utterance 760 of “to 10 minutes from now” may be input to the electronic device 101 and be transmitted to the intelligent server 200. The processor 520 may determine that the target utterance 760 has context information, which is a previous utterance, the utterance 720 of “Set the alarm”, may process the target utterance 760 using the context model 633 described with reference to FIG. 6, and may generate a processing result 770 of “The alarm is set to 10 minutes from now”.

The processor 520 may use, as context information, a previous utterance received within a certain time before receiving a target utterance, in processing the target utterance 760 of “to 10 minutes from now,” and may determine that there is no previous utterance when an utterance is received after the certain time. Referring to FIG. 7, the utterance situation 750 may be one in which the certain time after the utterance situation 710 has been exceeded, and the processor 520 may determine that there is no context information because a previous utterance, the utterance 720 of “Set the alarm”, is not determined to be the context information.

For example, the certain time for determining whether there is context information may be 10 seconds, and a continuous utterance, the target utterance 760 of “to 10 minutes from now”, may be transmitted to the intelligent server 200 20 seconds after the processor 520 generated the processing result 730 of “To what time do you want to set the alarm?” and output the generated processing result 730 to the electronic device 101. In this case, since the certain time for determining the context information set for the previous utterance has elapsed, and the processor 520 may thus determine that there is no context information for the continuous utterance and may process the continuous utterance using the root model 623, as described with reference to FIG. 6. When processing the target utterance 760 of “to 10 minutes from now” using the root model 623, an intent thereof may not be determined without context information, and the processor 520 may process the target utterance 760 using the inverse context model 660.

The learning data 540 may include “to 10 minutes from now” (utterance information), an “alarm application” (domain information), and “Set the alarm to 10 minutes from now with the alarm application” (intent information). The processor 520, with reference to the learning data 540, may determine domain information and intent information on the target utterance 760, may generate the processing result 770 of “The alarm is set to 10 minutes from now”, and output the generated processing result 770 to the user.

The processor 520 may process an incomplete continuous utterance without context information, when timed out, through the inverse context model 660.

Referring to FIG. 8, an example embodiment of processing a target utterance of “Buy eggs and carrots at 3 o'clock” is illustrated.

A situation 810 may be an operation of processing a target utterance when the inverse context model 660 described with reference to FIG. 6 is not applied. Referring to the situation 810, the processor 520 may process the target utterance 820 using the root model 623 because the processor 520 does not have context information on a target utterance 820 of “Buy eggs and carrots at 3 o'clock” and may determine that the processing is unperformable because there is no matched intent. For example, a processing result 830 of “You need to study more” may be generated and output to a user through the electronic device 101.

A situation 850 may be an operation of processing a target utterance in which the inverse context model 660 described with reference to FIG. 6 is applied. Referring to the situation 850, when a target utterance 860 of “Buy eggs and carrots at 3 o'clock” is not processible (unperformable) by the processor 520 using the root model 623 as described in the situation 810, the processor 520 may process, in operation 870, the target utterance 860 using the inverse context model 660. The processor 520, when determining, in operation 873, that there is no context information (context:null) and an utterance intent is not determinable by the root model 623, may process, in operation 875, the target utterance 860 using the inverse context model 660.

Domain information for processing the target utterance 860, with reference to the learning data 540, may be determined through the inverse context model 660, and in operation 878, a plurality of domains may be determined. The learning data 540 may include utterance information and domain information for processing the utterance information, for example, domain information related to a target utterance in the form of a list. For example, two domains, such as a reminder and a calendar, may correspond to an utterance of “Buy eggs and carrots at 3 o'clock”.

As described with reference to FIG. 6, the processor 520 may calculate a correspondence of each of the domains to a target utterance, and, when a correspondence of a domain having the highest correspondence is greater than or equal to a threshold, the processor 520 may generate a processing result based on the domain having the highest correspondence. For example, in operation 878, a correspondence of the reminder and a correspondence of the calendar may be calculated at 0.8 and 0.1, respectively, and a threshold may be 0.7. The correspondence of the reminder, which is a domain having the highest correspondence, is 0.8 and is greater than or equal to the threshold of 0.7, and thus, the processor 520 may generate a processing result 880 of “‘Buy eggs and carrots at 3 o'clock’ is stored as the reminder” based on the reminder. The processing result 880 may be output to a user through the electronic device 101.

The processor 520 may process even an incomplete utterance without context information through the inverse context model 660.

Referring to FIGS. 9A and 9B, examples of processing a target utterance of “Mark as all read” are illustrated.

Referring to FIG. 9A, situation 910 may be an operation of processing a target utterance when the inverse context model 660 is not applied as described with reference to FIG. 6. The processor 520 may process a target utterance 920 of “Mark as all read” using the root model 623 because there is no context information and may forcibly match the target utterance 920 with an arbitrarily set list, which is used many times, of a text message list and an email list. However, this may not correspond to an actual user's intent. For example, a user may make the target utterance 920 of “Mark as all read” with an intent of marking all emails as read, a processing result 930 of “All text messages were marked as read” may be generated, and a result not corresponding to a user's intent may be output to the user through the electronic device 101.

Referring to FIG. 9B, situation 950 may be an operation of processing a target utterance when the inverse context model 660 is applied as described with reference to FIG. 6. The processor 520 may process, in operation 970, the target utterance 960 of “Mark as all read” using the inverse context model 660. The processor 520, when determining, in operation 973, that there is no context information (Context:null) and an utterance is not processible (unperformable) by the root model 623, may process, in operation 975, the utterance using the inverse context model 660.

Domain information for processing the target utterance 960, with reference to the learning data 540, may be determined through the inverse context model 660, and in operation 978, a plurality of domains may be determined (identified). The learning data 540 may include, for example, two pieces of domain information, such as a text message and an email, as domains corresponding to the target utterance 960 of “Mark as all read”. The processor 520 may process multiple intents with reference to the learning data 540.

As described with reference to FIG. 6, the processor 520 may calculate a correspondence of each of the domains to a target utterance, and when a correspondence of a domain having the highest correspondence is less than a threshold, the processor 520 may generate a processing result of requesting user confirmation on a domain for processing the target utterance among the domains. For example, in operation 978, a correspondence of the text message and a correspondence of the email may be calculated at 0.5 and 0.4, respectively, and a threshold may be 0.7. The correspondence of the text message, which is the domain having the highest correspondence, is 0.5 and is less than the threshold of 0.7, and thus, the processor 520 may generate a processing result 980 of “Which of the following do you want to mark as read? 1. Text message 2. Email 3. Both”. The processing result 980 may be output to a user through the electronic device 101. When the user answers “Both”, the processor 520 may process both domains to be marked as all read by processing multiple intents.

Referring to FIG. 9B, an additional utterance 990 of “text only”, in response to the processing result 980, may be input to the electronic device 101 and may be transmitted to the intelligent server 200. The processor 520 may process the additional utterance 990 through the context model 633 using a previous utterance, which is the processing result 980, as context information. The processor 520 may process only text messages to be marked as read, generate a processing result 995 of “All text messages were marked as read”, and output the processing result 995 to the user through the electronic device 101.

When a user makes an ambiguous utterance, the processor 520 does not forcibly match the ambiguous utterance with an arbitrarily set list and may process the ambiguous utterance corresponding to a user's intent by determining a domain corresponding to an incomplete utterance through the inverse context model 660.

As described with reference to FIG. 5, the electronic device 101 may include on-device AI, and examples of processing utterances described with reference to FIGS. 7, 8, 9A, and 9B may be performed by the processor 120 of the electronic device 101 without communication with the intelligent server 200.

<Operating Method of Intelligent Server>

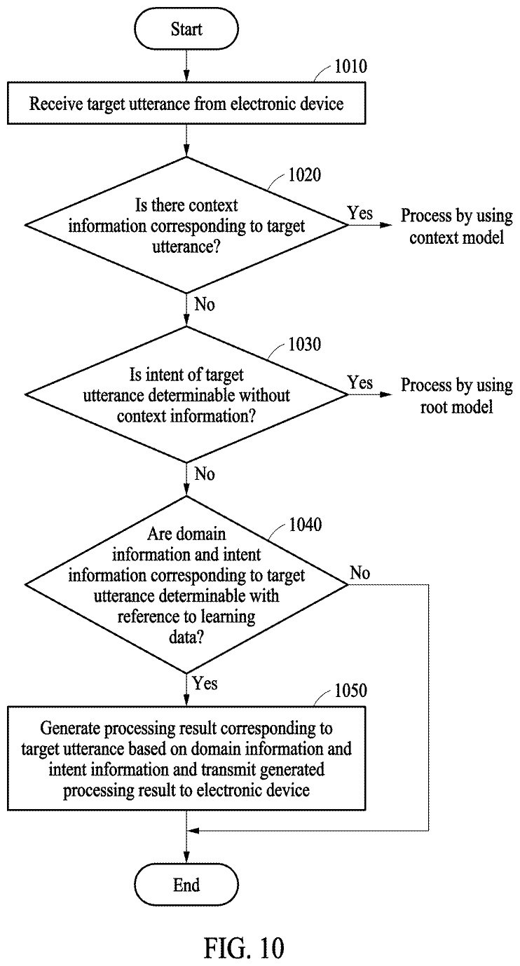

FIG. 10 is a flowchart illustrating an operation of processing an incomplete continuous utterance by an intelligent server, according to various example embodiments.

Operations 1010 through 1050 may be performed by the processor 520 of the intelligent server 200 described above with reference to FIG. 5. Therefore, the description provided with reference to FIGS. 1 through 9B is not repeated here.

In operation 1010, the processor 520 may receive a target utterance from the electronic device 101. In operation 1020, the processor 520 may determine whether there is context information corresponding to the target utterance. In operation 1020, the processor 520 may determine whether there is context information corresponding to the target utterance with reference to the natural language platform 220 and the capsule DB 230. For example, when receiving the utterance “to 10 minutes from now” after the utterance “Set the alarm”, a previous utterance, the utterance “Set the alarm”, may be determined to be context information corresponding to the utterance “to 10 minutes from now”. When there is context information corresponding to the target utterance, an intent may be determined based on the context model 633 described with reference to FIG. 6 and the processor 520 may generate a processing result based on the determined intent.

In operation 1030, the processor 520 may determine whether an intent of the target utterance is determinable without context information corresponding to the target utterance. For example, when receiving the utterance “Show me today's weather”, the processor 520 may determine whether an utterance intent is determinable without context information on an utterance situation using the root model 623 described with reference to FIG. 6. When an intent is determined based on the root model 623, the processor 520 may generate a processing result based on the determined intent.

When there is no context information corresponding to the target utterance and an intent is not determinable based on the root model 623 without context information, the processor 520 may determine, in operation 1040, whether domain information and intent information corresponding to the target utterance are determinable with reference to the learning data 540. If not, the process ends.

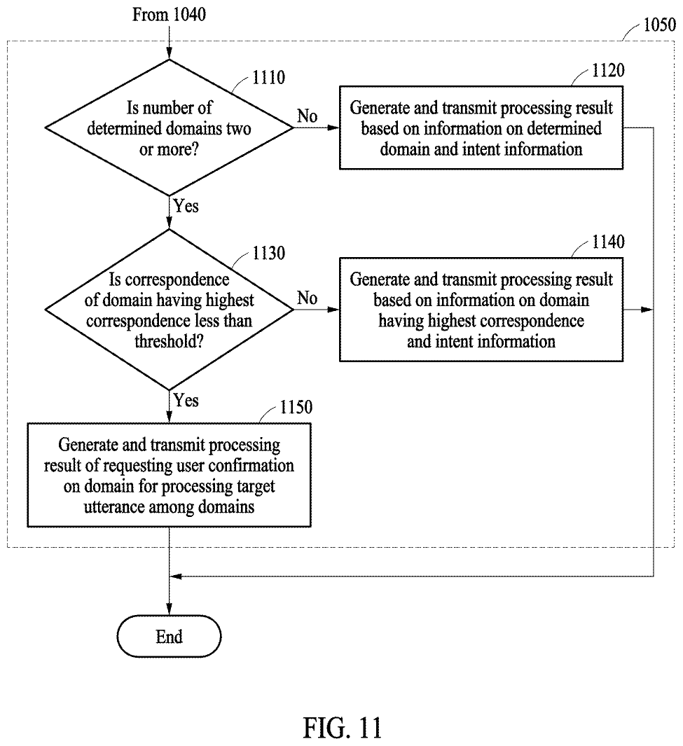

In operation 1050, the processor 520 may generate a processing result corresponding to the target utterance, based on the determined domain information and intent information, with reference to the learning data 540 and may transmit the processing result to the electronic device 101. In operation 1040, the number of determined domains may be plural, and as described above with reference to FIG. 6, the processor 520 may calculate a correspondence of each of the domains to the target utterance. An operation of generating a processing result when the number of domains is plural will be described in detail below with reference to FIG. 11.

Similar operations to operations 1010 through 1050 may be performed by the processor 120 of the electronic device 101. As described above with reference to FIG. 5, the electronic device 101 may include on-device AI for processing a user utterance without communication with the intelligent server 200, for example, the on-device AI may have a configuration similar to or the same as configurations of the natural language platform 220 and the capsule DB 230. The processor 120 may receive a target utterance from a user, determine domain information and intent information on the target utterance as determined in operations 1020 through 1030, generate a processing result based on the domain information and the intent information, and output the generated processing result to the user.

FIG. 11 is a flowchart illustrating an operation of an intelligent server when the number of domains corresponding to a target utterance is determined to be plural, according to various example embodiments.

Operations 1110 through 1150 may be performed by the processor 520 of the intelligent server 200 described above with reference to FIG. 5. Therefore, the descriptions provided with reference to FIGS. 1 through 10 are not repeated here.

Operations 1110 through 1150 may correspond to operations (e.g., operation 1050 of FIG. 10) for generating the processing result described with reference to FIG. 10.

In operation 1110, the processor 520 may determine whether the number of domains determined in operation 1040 is two or more. For example, as described with reference to FIGS. 8, 9A, and 9B, the learning data 540 may include domain information related to utterance information, for example, in the form of a list, and domains corresponding to a target utterance may be two or more. When the number of determined domains is not two or more (i.e., is one domain), the processor 520, in operation 1120, may generate a processing result based on information on the domain and intent information and may transmit the generated processing result to the electronic device 101.

When the number of determined domains is two or more, the processor 520, in operation 1130, may determine whether a correspondence of a domain having the highest correspondence is less than a threshold. As described with reference to FIGS. 6 and 8, 9A, and 9B, the processor 520 may calculate a correspondence between an utterance and a domain and compare the calculated correspondence with a set threshold.

When the correspondence of the domain having the highest correspondence is not less than the threshold (e.g., is greater than or equal to the threshold), the processor 520, in operation 1140, may generate a processing result, based on information on the domain having the highest correspondence and intent information, and may transmit the generated processing result to the electronic device 101. Descriptions provided with reference to FIG. 8 are applicable to operations 1130 and 1140, and thus, detailed descriptions thereof are not repeated here.

When the correspondence of the domain having the highest correspondence is less than the threshold, the processor 520, in operation 1150, may generate a processing result of requesting a user confirmation on a domain for processing the target utterance among the domains and may transmit the generated processing result to the electronic device 101. For example, as described with reference to FIG. 9B, the processor 520 may generate a processing result, which is the processing result 980, of requesting a user confirmation, and based on a user's answer, which is the additional utterance 990, may provide a final result, which is the processing result 995, to a user. Descriptions provided with reference to FIGS. 9A and 9B are applicable to operations 1130 and 1140, and thus, detailed descriptions thereof are not repeated here.

As described with reference to FIG. 10, when the electronic device 101 includes on-device AI, operations similar to operations 1110 through 1150 may be performed by the processor 120 of the electronic device 101. The processor 120 may output the processing results generated through operations 1120, 1140, and 1150 to the user.

According to an example embodiment, an intelligent server for processing a user utterance may receive a target utterance from an electronic device 101 and include a communication module 590 for transmitting a processing result of the target utterance to the electronic device 101, learning data 540 including utterance information, domain information for processing the utterance information, and intent information determined based on the utterance information and the domain information, a memory 530 for storing computer-executable instructions, and a processor 520 for executing the computer-executable instructions by accessing the memory 530. The computer-executable instructions may be configured to determine whether there is context information on a situation corresponding to the target utterance, when there is no context information on a situation corresponding to the target utterance, determine whether an intent of the target utterance is determinable without the context information, when the intent of the target utterance is not determinable without the context information, determine domain information and intent information corresponding to the target utterance with reference to the learning data 540, and generate a processing result based on the domain information and the intent information.

According to an example embodiment, the computer-executable instructions may be configured to, when there is not an utterance received within a certain time before receiving the target utterance from the electronic device 101, or when there is not an application being executed by the electronic device 101, determine that there is no context information on a situation corresponding to the target utterance.

According to an example embodiment, the computer-executable instructions may be configured to, when an utterance received within a certain time before receiving the target utterance from the electronic device 101 is irrelevant to the target utterance or an application being executed by the electronic device 101 is irrelevant to the target utterance, determine that there is no context information on a situation corresponding to the target utterance.

According to an example embodiment, the learning data 540 may be used in a learning engine that is implemented in the form of a rule engine, and based on the rule engine, the computer-executable instructions may be configured to determine domain information and intent information corresponding to the target utterance.

According to another example embodiment, the learning data 540 may be used in a learning engine that is implemented in the form of a neural network engine, and based on a result derived by inputting a target utterance to the neural network engine, the computer-executable instructions may be configured to determine domain information and intent information.

According to an example embodiment, the computer-executable instructions may be configured to, when the number of domains determined with reference to the learning data 540 is plural and a correspondence of a domain having the highest correspondence is greater than or equal to a threshold, generate a processing result of the target utterance, based on information on the domain having the highest correspondence and intent information.

According to an example embodiment, the computer-executable instructions may be configured to, when the number of domains determined with reference to the learning data 540 is plural and the correspondence of the domain having the highest correspondence is less than the threshold, generate a processing result of requesting a user confirmation on a domain for processing the target utterance among the domains.

According to an example embodiment, context information may include at least one of history information on utterances received by an electronic device, information on applications executed by the electronic device, history information on utterances received by another electronic device connected to the electronic device, and information on applications executed by the other electronic device.

The domain may be software for processing a target utterance through the electronic device 101 and may include at least one of an application downloadable to the electronic device 101, a program for providing a service in the form of a widget, and a web app.

According to an example embodiment, a processing method of a user utterance in an intelligent server 200 may include receiving a target utterance from an electronic device 101, determining whether there is context information on a situation corresponding to the target utterance, when there is no context information on a situation corresponding to the target utterance, determining whether an intent of the target utterance is determinable without the context information, when the intent of the target utterance is not determinable without the context information, determining domain information and intent information corresponding to the target utterance with reference to learning data 540, and generating a processing result on the target utterance based on the domain information and the intent information and transmitting the generated processing result to the electronic device 101. According to an example embodiment, the learning data 540 may include utterance information, domain information for processing the utterance information, and intent information determined based on the utterance information and the domain information.

According to an example embodiment, the determining whether there is context information on a situation corresponding to the target utterance may include, when there is not an utterance received within a certain time before receiving the target utterance from the electronic device 101, or when there is not an application being executed by the electronic device 101, determining that there is no context information on a situation corresponding to the target utterance.

According to an example embodiment, the determining whether there is context information on a situation corresponding to the target utterance may include, when an utterance received within a certain time before receiving the target utterance from the electronic device 101 is irrelevant to the target utterance or an application being executed by the electronic device 101 is irrelevant to the target utterance, determining that there is no context information on a situation corresponding to the target utterance.

According to an example embodiment, the learning data 540 may be used in a learning engine that is implemented in the form of a neural network engine, and domain information and intent information may be determined based on a rule engine.

According to another example embodiment, the learning data 540 may be used in a learning engine that is implemented in the form of a neural network engine, and domain information and intent information may be determined based on a result derived by inputting the target utterance to the neural network engine.

According to an example embodiment, the generating a processing result of the target utterance may include, when the number of domains determined with reference to the learning data 540 is plural and a correspondence of a domain having the highest correspondence is greater than or equal to a threshold, generating a processing result of the target utterance, based on information on the domain having the highest correspondence and intent information.

According to an example embodiment, the generating a processing result of the target utterance may include, when the number of domains determined with reference to the learning data 540 is plural and the correspondence of the domain having the highest correspondence is less than the threshold, generating a processing result of requesting a user confirmation on a domain for processing the target utterance among the domains.

According to an example embodiment, an electronic device 101 configured to process a user utterance includes a memory configured to store utterance information, domain information for processing the utterance information, learning data 540 including intent information determined based on the utterance information and the domain information, and computer-executable instructions; and a processor 120 configured to execute the computer-executable instructions by accessing the memory 130, in which the computer-executable instructions are configured to determine whether there is context information on a situation corresponding to the target utterance received from a user, when there is no context information on a situation corresponding to the target utterance, determine whether an intent of the target utterance is determinable without the context information on a situation corresponding to the target utterance, when the intent of the target utterance is not determinable without the context information on a situation corresponding to the target utterance, determine domain information and intent information, corresponding to the target utterance, with reference to the learning data 540, and generate the processing result, based on the domain information and the intent information, corresponding to the target utterance, and output the generated processing result to the user.

According to an example embodiment, the computer-executable instructions may be configured to, when an utterance received within a certain time before receiving the target utterance from a user is irrelevant to the target utterance or an application being executed by the electronic device 101 is irrelevant to the target utterance, determine that there is no context information on a situation corresponding to the target utterance.

According to an example embodiment, the computer-executable instructions may be configured to, when the number of domains determined with reference to the learning data 540 is plural and the correspondence of the domain having the highest correspondence is less than the threshold, generate a processing result of requesting a user confirmation on which domain is used to process the target utterance among the domains, and output the generated processing result to the user.

What is claimed is:

1. An intelligent server configured to process a user utterance, the intelligent server comprising:
a communication module including communication circuitry configured to receive a target utterance from an electronic device and transmit a processing result of the target utterance to the electronic device;
a memory configured to store utterance information, domain information for processing the utterance information, learning data including intent information determined based on the utterance information and the domain information, and computer-executable instructions; and
a processor configured to execute the computer-executable instructions by accessing the memory,
wherein
the computer-executable instructions configure the processor to:
determine whether there is context information on a situation corresponding to the target utterance,
based on determining that there is no context information on a situation corresponding to the target utterance, determine whether an intent of the target utterance is determinable without the context information on a situation corresponding to the target utterance,
based on the intent of the target utterance not being determinable without the context information on a situation corresponding to the target utterance, identify domain information and intent information, corresponding to the target utterance, with reference to the learning data, and
generate the processing result, based on the domain information and the intent information, corresponding to the target utterance.

2. The intelligent server of claim 1, wherein
the computer-executable instructions configure the processor to:
based on no utterance being received within a certain time before receiving the target utterance from the electronic device, or based on no application being executed by the electronic device, determine that there is no context information on a situation corresponding to the target utterance.

3. The intelligent server of claim 1, wherein
the computer-executable instructions configure the processor to:
based on an utterance received within a certain time before receiving the target utterance from the electronic device being irrelevant to the target utterance or based on an application being executed by the electronic device being irrelevant to the target utterance, determine that there is no context information on a situation corresponding to the target utterance.

4. The intelligent server of claim 1, wherein
the learning data is used in a learning engine implemented in the form of a rule engine, and
the computer-executable instructions configure the processor to determine the domain information and the intent information, corresponding to the target utterance, based on the rule engine.

5. The intelligent server of claim 1, wherein
the learning data is used in a learning engine implemented in the form of a neural network engine, and
the computer-executable instructions configure the processor to determine the domain information and the intent information, based on a result derived by inputting the target utterance to the neural network engine.

6. The intelligent server of claim 1, wherein
the computer-executable instructions configure the processor to:
based on the number of domains determined with reference to the learning data being plural and a correspondence of a domain having the highest correspondence being greater than or equal to a threshold, generate a processing result of the target utterance, based on information on the domain having the highest correspondence and the intent information.

7. The intelligent server of claim 1, wherein
the computer-executable instructions configure the processor to:
based on the number of domains determined with reference to the learning data being plural and a correspondence of a domain having the highest correspondence being less than a threshold, generate a processing result requesting a user confirmation on a domain for processing the target utterance among the domains.

8. The intelligent server of claim 1, wherein
the context information comprises at least one of history information on utterances received by the electronic device, information on applications executed by the electronic device, history information on utterances received by another electronic device connected to the electronic device, or information on applications executed by the other electronic device.

9. The intelligent server of claim 1, wherein
the domain comprises software configured to process the target utterance through the electronic device, and the software comprises at least one of an application downloadable to the electronic device, a program for providing a service in the form of a widget, or a web app.

10. A method of processing a user utterance in an intelligent server, the method comprising:
receiving a target utterance from an electronic device;
determining whether there is context information on a situation corresponding to the target utterance;
based on determining that there is no context information on a situation corresponding to the target utterance, determining whether an intent of the target utterance is determinable without the context information on a situation corresponding to the target utterance;
based on the intent of the target utterance not being determinable without the context information on a situation corresponding to the target utterance, identifying domain information and intent information, corresponding to the target utterance, with reference to learning data; and
generating a processing result of the target utterance, based on the domain information and the intent information, and transmitting the generated processing result to the electronic device,
wherein
the learning data comprises utterance information, domain information for processing the utterance information, and intent information determined based on the utterance information and the domain information.

11. The method of claim 10, further comprising:
based on no utterance being received within a certain time before receiving the target utterance from the electronic device, or based on no application being executed by the electronic device, determining that there is no context information on a situation corresponding to the target utterance.

12. The method of claim 10, further comprising:
based on an utterance received within a certain time before receiving the target utterance from the electronic device being irrelevant to the target utterance or based on an application being executed by the electronic device being irrelevant to the target utterance, determining that there is no context information on a situation corresponding to the target utterance.

13. The method of claim 10, wherein
the learning data is used in a learning engine implemented in the form of a neural network engine, and
the domain information and the intent information are determined based on a rule engine.

14. The method of claim 10, wherein
the learning data is used in a learning engine implemented in the form of a neural network engine, and
the domain information and the intent information are determined based on a result derived by inputting the target utterance to the neural network engine.

15. The method of claim 10, further comprising:
based on the number of domains determined with reference to the learning data being plural and a correspondence of a domain having the highest correspondence being greater than or equal to a threshold,
generating a processing result of the target utterance, based on information on the domain having the highest correspondence and the intent information.

16. The method of claim 10, further comprising:
based on the number of domains determined with reference to the learning data being plural and a correspondence of a domain having the highest correspondence being less than a threshold, generating a processing result requesting a user confirmation on a domain for processing the target utterance among the domains.

17. A non-transitory computer-readable storage medium storing instructions that, when executed by a processor, cause the processor to perform the method of claim 10.

18. An electronic device configured to process a user utterance, the electronic device comprising:
a memory configured to store utterance information, domain information for processing the utterance information, learning data including intent information determined based on the utterance information and the domain information, and computer-executable instructions; and
a processor configured to execute the computer-executable instructions by accessing the memory,
wherein
the computer-executable instructions configure the processor to:
determine whether there is context information on a situation corresponding to a target utterance received from a user,
based on determining that there is no context information on a situation corresponding to the target utterance, determine whether an intent of the target utterance is determinable without the context information on a situation corresponding to the target utterance,
based on the intent of the target utterance not being determinable without the context information on a situation corresponding to the target utterance, determine domain information and intent information, corresponding to the target utterance, with reference to the learning data, and
generate the processing result, based on the domain information and the intent information, corresponding to the target utterance, and output the generated processing result to the user.

19. The electronic device of claim 18, wherein
the computer-executable instructions configure the processor to:
based on no utterance being received within a certain time before receiving the target utterance from the user or an application being executed by the electronic device being irrelevant to the target utterance, determine that there is no context information on a situation corresponding to the target utterance.

20. The electronic device of claim 18, wherein
the computer-executable instructions configure the processor to:
based on the number of domains determined with reference to the learning data being plural and a correspondence of a domain having the highest correspondence being less than a threshold, generate a processing result requesting a user confirmation on which domain, among the domains, is used to process the target utterance, and output the generated processing result to the user.
